(19) United States
(12) Patent Application Publication
(10) Pub. No.: US 2010/0106462 A1
(43) Pub. Date: Apr. 29, 2010

(54) Systems and Methods for Diagnosing Gas Turbine Engine Faults

(75) Inventor: Jun Liu, Hartford, CT (US)

Correspondence Address: CARLSON, GASKEY & OLDS/PRATT & WHITNEY, 400 WEST MAPLE ROAD, SUITE 350, BIRMINGHAM, MI, 48009, US

(73) Assignee: UNITED TECHNOLOGIES CORP., Hartford, CT (US)

(21) Appl. No.: 12/259,448

(22) Filed: Oct. 28, 2008

(51) Int. Cl. G06F 15/00; G06F 17/18; G01M 15/14

(52) U.S. Cl. 702/185; 702/181

(57) ABSTRACT

Systems and methods for diagnosing gas turbine engine faults are provided. In this regard, a representative method includes: dynamically assessing detected symptoms based, at least in part, on failure rates of components of the gas turbine engine as functions of usage of the components such that suspected faults are identified.

### STATEMENT REGARDING FEDERALLY SPONSORED RESEARCH AND DEVELOPMENT

The U.S. Government may have an interest in the subject matter of this disclosure as provided for by the terms of contract number N00019-02-C-3003 awarded by the United States Navy.

### BACKGROUND

1. Technical Field

The disclosure generally relates to fault diagnosis of gas turbine engines.

2. Description of the Related Art

Engine diagnostic systems perform fault isolation functions that oftentimes involve ranking of probable faults. Such a fault ranking can be used to drive troubleshooting and maintenance procedures. Thus, the higher the true fault is ranked, the sooner the true fault typically is confirmed and corrected.

### SUMMARY

Systems and methods for diagnosing gas turbine engine faults are provided. In this regard, a representative embodiment of a method comprises: receiving a fault signal from an engine; determining the dynamic failure rate; and correlating the fault signal to the dynamic failure rate to identify a range of suspected faults.

Another exemplary embodiment of a method for diagnosing gas turbine engine faults comprises: dynamically assessing detected symptoms based, at least in part, on failure rates of components of the gas turbine engine as functions of usage of the components such that suspected faults are identified.

An exemplary embodiment of a gas turbine engine system comprises: an analysis system operative to receive information corresponding to a detected fault symptom of a gas turbine engine, receive information corresponding to dynamic failure rates of components of the gas turbine engine, and identify suspected faults of the gas turbine engine by correlating the information corresponding to the dynamic failure rates with the information corresponding to a detected symptom.

Other systems, methods, features and/or advantages of this disclosure will be or may become apparent to one with skill in the art upon examination of the following drawings and detailed description. It is intended that all such additional systems, methods, features and/or advantages be included within this description and be within the scope of the present disclosure.

### BRIEF DESCRIPTION OF THE DRAWINGS

Many aspects of the disclosure can be better understood with reference to the following drawings. The components in the drawings are not necessarily to scale. Moreover, in the drawings, like reference numerals designate corresponding parts throughout the several views.

FIG. 1 is a schematic diagram of an embodiment of a gas turbine engine.

FIG. 2 is a flowchart depicting functionality of an embodiment of a system for diagnosing gas turbine engine faults.

FIG. 3 is a schematic diagram of an embodiment of a system for diagnosing a gas turbine engine.

### DETAILED DESCRIPTION

Systems and methods for diagnosing gas turbine engine faults are provided, several exemplary embodiments of which will be described. In this regard, diagnosing of faults involves fault isolation, in which a group of suspected faults (known as an ambiguity group) is identified. Various techniques can be used to differentiate among the suspected faults of an ambiguity group, such as by ranking the suspected faults based on the relative probabilities of occurrence. Notably, failure rates of components implicated by the suspected faults are analyzed as functions of usage of the components. This is in contrast to conventional techniques that may consider a component failure rate to be constant throughout the life of a component. Notably, components can exhibit failure distributions that vary relatively significantly over time, such as failure distributions that are bell-shaped, with peak failures tending to occur at particular usage measurement units (e.g., a given number of flight hours). Other components may exhibit basin-shaped failure distributions with relatively high failure rates at both low and high usage times.

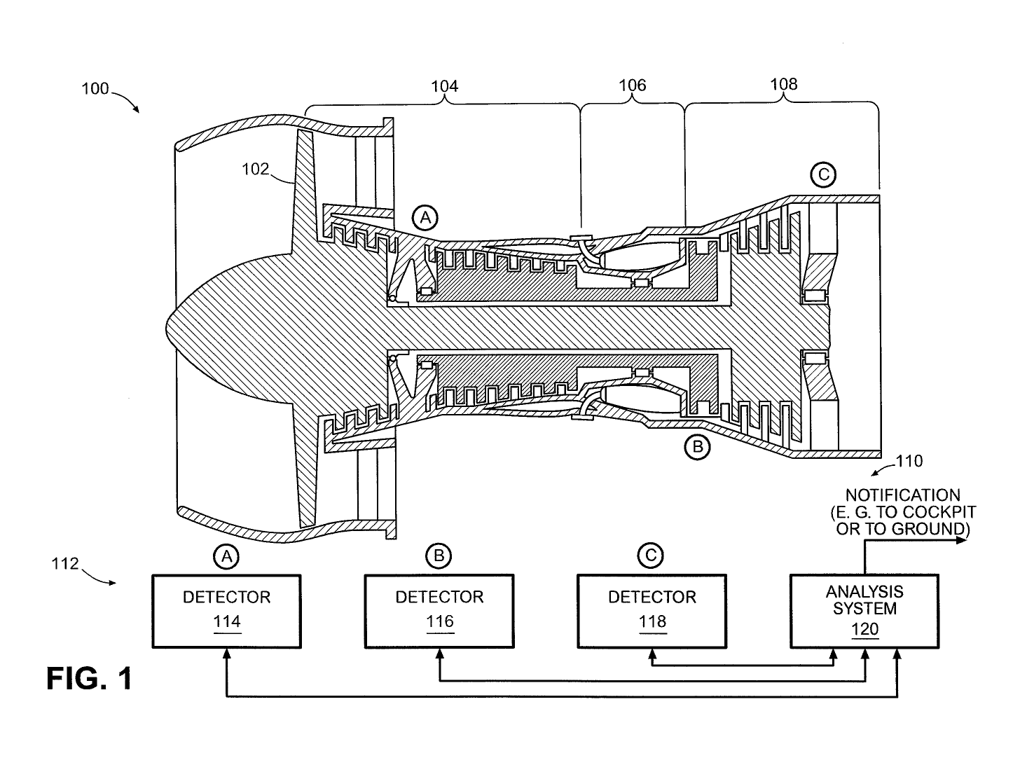

Reference now made to FIG. 1, which schematically depicts an embodiment of a gas turbine engine. As shown in FIG. 1, engine 100 incorporates a fan 102, a compressor section 104, a combustion section 106 and a turbine section 108. Although engine 100 is configured as a turbofan, there is no intention to limit the concepts to use with turbofans as use with other types of gas turbine engines also is contemplated.

Engine 100 also includes a diagnostic system 110 that includes a monitoring system 112 and an analysis system 120. Monitoring system 112 is depicted as including detectors 114, 116 and 118 positioned at locations A, B and C, respectively. The detectors monitor various parameters of the engine and provide information corresponding to those parameters to the analysis system. Various types of detectors can be used to monitor a variety of parameters such as vibrations, pressures and temperatures, for example. Parameters failing to meet predetermined criteria can be considered symptoms of a suspected fault. Notably, other types, numbers and positions of detectors can be used in other embodiments.

The analysis system 120 dynamically assesses detected symptoms based, at least in part, on failure rates of components of the gas turbine engine as functions of usage of the components. This enables the analysis system to identify and potentially rank the suspected faults. In some embodiments, depending upon the severity of a suspected fault, for example, a notification can be provided to the cockpit of an aircraft to which the gas turbine engine is mounted for informing the aircrew of the suspected condition. Additionally or alternatively, information can be provided to ground personnel, such as via a wired or wireless interface. In the case of wireless transmission, some embodiments could transmit information corresponding to the suspected faults prior to engine shutdown, such as during flight.

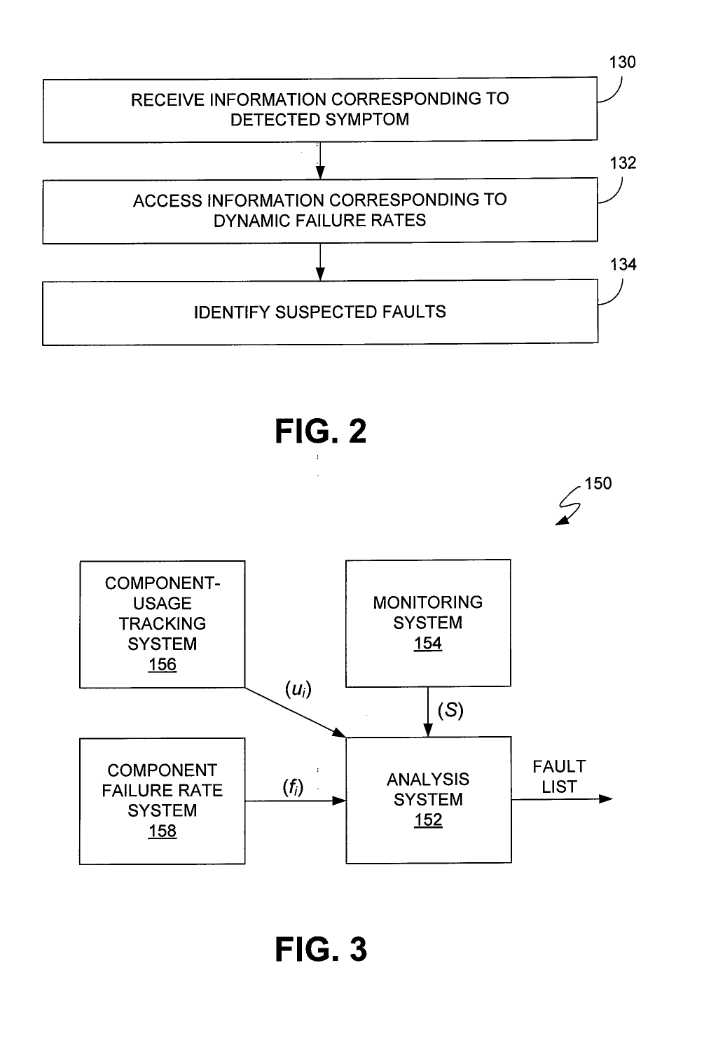

FIG. 2 is a flowchart depicting functionality of an embodiment of a system for diagnosing gas turbine engine faults, such as that implemented by diagnosis system 110 of FIG. 1. As shown in FIG. 2, the functionality (or method) may be construed as beginning at block 130, in which information corresponding to at least one detected symptom is received. In block 132, information corresponding to dynamic failure rates of components of the gas turbine engine is accessed. Then, as depicted in block 134, one or more suspected faults attributable to the at least one detected symptom (or symptoms) are identified. This is accomplished by correlating the information corresponding to the dynamic failure rates with the information corresponding to a detected symptom. Notably, dynamic failure rates constitute a correlation between component life usage of a component of interest and historical failure rates of like components with respect to usage. In some embodiments, the historical failure rates can comprise data associated with numerous ones of various engine components (e.g., fleet-wide data) that is periodically updated. Thus, a dynamic failure rate of a component of interest is a failure rate computed by correlating the historical failure rates of like components with the particular usage exhibited by the component of interest. In some embodiments, at least some of the aforementioned functions can be performed while the gas turbine engine is operating (e.g., in flight).

FIG. 3 is a schematic diagram of another embodiment of a system for diagnosing a gas turbine engine. Functionality of the system of FIG. 3 may be generally construed as involving: receiving a fault signal from an engine; determining the dynamic failure rate; and correlating the fault signal to the dynamic failure rate to identify a range of suspected faults, the probability of which can optionally be ranked. Notably, the dynamic failure rate is determined by accessing historical information about the engine and comparing the historical information to a failure rate database for comparable engines.

As shown in FIG. 3, system 150 includes an analysis system 152, monitoring system 154, a component-usage tracking system 156 and component failure rate system 158. In operation, monitoring system 154 provides information (S) corresponding to detected symptoms to the analysis system. Additionally, the analysis system receives information (uᵢ) corresponding to component usage from the component-usage tracking system 156. Tracking system 156 stores information regarding the usage time of various components. In some embodiments, the information can be updated, such as when a component is altered. For instance, if a component is repaired, refurbished or replaced (e.g., replaced with a new component), information corresponding to the altered state of the component can be maintained by the tracking system.

Component failure rate system 158 provides component failure rate information (fᵢ) to the analysis system. In some embodiments, the component failure rate information is provided in the form of a failure rate curve that plots failure of a component of interest against usage time. Notably, a designated engine component can have more than one set of failure rate information associated therewith. By way of example, in some embodiments, failure rate information can be stored with respect to OEM components and repaired components, with an appropriate set of the information being accessed depending upon the nature of the component of interest.

Using the information available to the analysis system, the analysis system outputs suspected faults that are ranked. Notably, the ranking is based, at least in part, on the dynamic fault rates (i.e., the fault rate information correlated with the actual usage time of the components).

The following outlines an exemplary methodology for diagnosing suspected engine faults. In this regard, assume that N types of engine faults (F₁, F₂, . . . , F_{N}) are being monitored. The failure rate fᵢ associated with fault Fᵢ is the occurrence frequency of that fault within a given amount of time (e.g., one million flight hours). Let S₁, S₂, . . . , S_{M} be symptoms that can be detected by the diagnostic system. Then, the task of fault isolation in the diagnostic system is to provide a ranked component list that is associated with a subset of faults F₁, F₂, . . . , F_{N}, if a subset S of symptoms S₂, . . . , S_{M} is detected.

Providing such ranked fault list can be based on the magnitudes of conditional probabilities of the faults given a subset of detected symptoms. Using the Bayesian formula, the rank for the ith fault is

Rank(i)=p(Fᵢ|S)

=p(Fᵢ)×p(S|Fᵢ)/p(S) (1)

where:
S is the subset of symptoms detected;
p(Fᵢ|S) is the conditional probability that the ith fault Fᵢ occurs given S is detected;
p(Fᵢ) is the probability of fault Fᵢ;
p(S|Fᵢ) is the conditional probability that S would be detected if the fault Fᵢ occurs; and
p(S) is the probability that S would be detected.
   The index i typically involves only those faults that are related to the detected symptoms. The indexes of these faults can be denoted as I.

In Equation 1, p(S) is a common denominator, independent of index i, and can be calculated as

$$p ( S ) = {\sum }_{i ∈ I} p ( {F}_{i} ) \times p ( S \vert {F}_{i} ) .$$

p(S|Fᵢ) can be calculated from a Fault-Symptom model, usually a Bayesian Network model. Finally, p(Fᵢ) can be calculated using failure rates of involved faults, i.e.

$$p ( {F}_{i} ) = {f}_{i} / {\sum }_{k = 1}^{N} {f}_{k} , i ∈ I . \qquad ( 2 )$$

As mentioned before, in this example failure rate is the occurrence frequency of a fault within one million flight hours. Such a failure rate can be estimated from historical maintenance records of, may be, multiple engine types. Unfortunately, a failure rate estimated in this manner may not reflect true failure rates of components associated with the specific engine type that the diagnostic system is monitoring. Moreover, such a failure rate may be assumed to be constant with respect to the life of a component. For many engine components, such an assumption also may not be true.

In this regard, the failure rate curve for each implicated component can be used to calculate failure probability in Equation 2 above. Thus, the failure rate is the failure likelihood as a function of component life usage. Stated otherwise, the failure rate curve (or failure distribution curve) for each possible fault (failure mode) is probability distribution function with respect to life usage index for each component and is substituted into Equation 2. Such a failure rate curve for the ith fault is denoted as fᵢ(uᵢ), where uᵢ is the life usage index for the ith component fault generated by a component-usage tracking system at the time the symptoms S are detected. Then, the Equation 2 that calculates fault probability becomes

$$p ( {F}_{i} ) = {f}_{i} ( {u}_{i} ) / {\sum }_{k = 1}^{N} {f}_{k} ( {u}_{k} ) , i ∈ I . \qquad ( 3 )$$

Using Equation (3), the probability of fault can be calculated more accurately, and hence the fault ranking generated by Equation 1 can be improved. That is, the likelihood of a true fault being ranked higher relative to other fault rankings increases. Furthermore, in cases in which fᵢ(uᵢ) equals zero at a given component usage for some faults i, the ranked fault list will be shorter, resulting in a reduced ambiguity group size. The benefit of the concept explained above can be demonstrated through following abstract example.

Consider a scenario that a gas turbine engine has operated for 900 hours since installed to aircraft, and all components have the same life usage (900 hours). A subset of symptoms S is then detected, indicating a functional failure occurs. Assume two faults, F₁ and F₂, are the only possible root causes equally likely responsible for the detected S, meaning p(S|F₁)=p(S|F₂)≠0. Furthermore, assume the failure rate for the fault F₁ is 5 occurrences per million fight hours, and the failure rate for the fault F₂ is 3 occurrences per million fight hours. Assume also the failure rate distributions are available, given in Table 1:

TABLE 1

| | Life Usage uᵢ in | | | |
|---|---|---|---|---|
| | Flight Hours | | | |
| | | | | Total |
| | 0~1,000 | 1,001~2,000 | 2,001~4,000 | Occurrence |
| Failure rate f₁ for | 1 | 1 | 3 | 5 |
| F₁ | | | | |
| Failure rate f₂ for | 2 | 1 | 0 | 3 |
| F₂ | | | | |

The task for the diagnostic system is to identify the real fault by properly ranking the ambiguity group, {F₁, F₂} in this case, such that the real fault is ranked higher.

With a conventional method, where the failure rate fᵢ is assumed being constant, the fault probabilities and the ranks for both faults are calculated using Equation (2) as:

$$p ( {F}_{1} ) = {f}_{1} / {\sum }_{k = 1}^{2} {f}_{k} = \frac{5}{5 + 3} = 0.625$$

$$p ( {F}_{1} ) = {f}_{1} / {\sum }_{k = 1}^{2} {f}_{k} = \frac{3}{5 + 3} = 0.375$$

$$Rank ( 1 ) = p ( {F}_{1} ) \times p ( S \vert {F}_{1} ) / p ( S ) = 0.625 \times p ( S \vert {F}_{1} ) / p ( S )$$

$$Rank ( 2 ) = p ( {F}_{2} ) \times p ( S \vert {F}_{2} ) / p ( S ) = 0.375 \times p ( S \vert {F}_{2} ) / p ( S )$$

Thus, the rank for F₁ is higher than that for F₂, i.e. Rank (1)≧Rank (2) since p(S|F₁)=p(S|F₂), and p(S) are common denominators to both ranks.

In some embodiments of a diagnostic system, the fault probabilities and the ranks for both faults can be calculated using Equation (3) as

$$\begin{matrix}\begin{matrix}p ( {F}_{1} ) = {f}_{1} ( {u}_{1} ) / {\sum }_{k = 1}^{2} {f}_{k} ( {u}_{k} ) \\ = {f}_{1} ( 900 ) / {\sum }_{k = 1}^{2} {f}_{k} ( 900 ) \\ = \frac{1}{1 + 2} \\ = 0.333\end{matrix} & \\ \begin{matrix}p ( {F}_{1} ) = {f}_{1} ( {u}_{2} ) / {\sum }_{k = 1}^{2} {f}_{k} ( {u}_{k} ) \\ = {f}_{2} ( 900 ) / {\sum }_{k = 1}^{2} {f}_{k} ( 900 ) \\ = \frac{2}{1 + 2} \\ = 0.667\end{matrix} \\ Rank ( 1 ) = p ( {F}_{1} ) \times p ( S \vert {F}_{1} ) / p ( S ) = 0.333 \times p ( S \vert {F}_{1} ) / p ( S ) \\ Rank ( 2 ) = p ( {F}_{2} ) \times p ( S \vert {F}_{2} ) / p ( S ) = 0.667 \times p ( S \vert {F}_{2} ) / p ( S ) & \end{matrix}$$

Thus, the rank for F₁ is lower than that for F₂, i.e. Rank (1)≦Rank (2).

As shown in the failure rate table, it can be seen that even though the total failure occurrences for F₁ is higher than that for F₂ for one million fight hours, for the given scenario the fault 2 is twice more likely occurred than the fault 1 at usage life 900 hours. Hence, ranking the fault 2 higher than fault 1 twice more likely provides correct ranking than the conventional method. It should be emphasized that the intent is not to provide correct ranking every single time, but rather to increase the likelihood of correct ranking.

Various functionalities, such as that described above in the flowcharts can be implemented in hardware and/or software. In this regard, a computing device can be used to implement various functionality, such as that depicted in FIG. 2 and/or that attributable to a diagnosis system, analysis system, monitoring system, component-usage tracking system and/or component failure rate system.

In terms of hardware architecture, such a computing device can include a processor, memory, and one or more input and/or output (I/O) device interface(s) that are communicatively coupled via a local interface. The local interface can include, for example but not limited to, one or more buses and/or other wired or wireless connections. The local interface may have additional elements, which are omitted for simplicity, such as controllers, buffers (caches), drivers, repeaters, and receivers to enable communications. Further, the local interface may include address, control, and/or data connections to enable appropriate communications among the aforementioned components.

The processor may be a hardware device for executing software, particularly software stored in memory. The processor can be a custom made or commercially available processor, a central processing unit (CPU), an auxiliary processor among several processors associated with the computing device, a semiconductor based microprocessor (in the form of a microchip or chip set), a microprocessor, or generally any device for executing software instructions.

The memory can include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). Moreover, the memory may incorporate electronic, magnetic, optical, and/or other types of storage media. Note that the memory can also have a distributed architecture, where various components are situated remotely from one another, but can be accessed by the processor.

The software in the memory may include one or more separate programs, each of which includes an ordered listing of executable instructions for implementing logical functions. A system component embodied as software may also be construed as a source program, executable program (object code), script, or any other entity comprising a set of instructions to be performed. When constructed as a source program, the program is translated via a compiler, assembler, interpreter, or the like, which may or may not be included within the memory.

The Input/Output devices that may be coupled to system I/O Interface(s) may include input devices, for example but not limited to, a keyboard, mouse, scanner, microphone, camera, proximity device, etc. Further, the Input/Output devices may also include output devices, for example but not limited to, a printer, display, etc. Finally, the Input/Output devices may further include devices that communicate both as inputs and outputs, for instance but not limited to, a modulator/demodulator (modem; for accessing another device, system, or network), a radio frequency (RF) or other transceiver, a telephonic interface, a bridge, a router, etc.

When the computing device is in operation, the processor can be configured to execute software stored within the memory, to communicate data to and from the memory, and to generally control operations of the computing device pursuant to the software. Software in memory, in whole or in part, is read by the processor, perhaps buffered within the processor, and then executed.

One should note that the flowcharts included herein show the architecture, functionality, and operation of a possible implementation of software. In this regard, each block can be interpreted to represent a module, segment, or portion of code, which comprises one or more executable instructions for implementing the specified logical function(s). It should also be noted that in some alternative implementations, the functions noted in the blocks may occur out of the order and/or not at all. For example, two blocks shown in succession may in fact be executed substantially concurrently or the blocks may sometimes be executed in the reverse order, depending upon the functionality involved.

One should note that any of the functionality described herein can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” contains, stores, communicates, propagates and/or transports the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of a computer-readable medium include a portable computer diskette (magnetic), a random access memory (RAM) (electronic), a read-only memory (ROM) (electronic), an erasable programmable read-only memory (EPROM or Flash memory) (electronic), and a portable compact disc read-only memory (CDROM) (optical).

It should be emphasized that the above-described embodiments are merely possible examples of implementations set forth for a clear understanding of the principles of this disclosure. Many variations and modifications may be made to the above-described embodiments without departing substantially from the spirit and principles of the disclosure. All such modifications and variations are intended to be included herein within the scope of this disclosure and protected by the accompanying claims.

1. A method comprising:
receiving a fault signal from an engine;
determining the dynamic failure rate; and
correlating the fault signal to the dynamic failure rate to identify a range of suspected faults.

2. The method of claim 1, wherein the dynamic failure rate is determined by accessing historical information about the engine and comparing the historical information to a failure rate database for comparable engines.

3. The method of claim 1, further comprising ranking the probability of suspected faults.

4. The method of claim 3, further comprising using the ranking to drive troubleshooting.

5. The method of claim 1, further comprising updating the dynamic failure rate.

6. The method of claim 5, wherein the updating comprises:
determining that one of the components of the gas turbine engine has been altered; and
modifying the dynamic failure rate of the one of the components to encompass effects attributable to alterations performed with respect to the one of the components.

7. The method of claim 6, wherein the alterations performed with respect to the one of the components comprises replacing the one of the components.

8. The method of claim 1, wherein the range of suspected faults is used to drive troubleshooting.

9. The method of claim 1, wherein the engine is a gas turbine engine.

10. The method of claim 1, wherein the receiving, determining and correlating are performed while the engine is operating.

11. A method for diagnosing gas turbine engine faults comprising dynamically assessing detected symptoms based, at least in part, on failure rates of components of the gas turbine engine as functions of usage of the components such that suspected faults are identified.

12. The method of claim 11, wherein the failure rates of at least some of the components vary with respect to usage of the components.

13. The method of claim 11, further comprising:
ranking the suspected faults; and
using the ranking to drive troubleshooting of the suspected faults.

14. The method of claim 11, further comprising sending a notification corresponding to the suspected faults.

15. A gas turbine engine system comprising:
an analysis system operative to receive information corresponding to a detected fault symptom of a gas turbine engine, receive information corresponding to dynamic failure rates of components of the gas turbine engine, and identify suspected faults of the gas turbine engine by correlating the information corresponding to the dynamic failure rates with the information corresponding to a detected symptom.

16. The system of claim 15, wherein:
each of the dynamic failure rates corresponds to failure rate of a component over time; and
the system further comprises a component-usage tracking system operative to access information corresponding to usage of the components such that a current usage of a component of interest can be correlated with a corresponding one of the dynamic failure rates to provide a current expected failure rate for the component of interest.

17. The system of claim 16, wherein the component-usage tracking system is operative to track usage of the components.

18. The system of claim 15, further comprising a monitoring system operative to obtain information corresponding to detected fault symptoms of a gas turbine engine.

19. The system of claim 15, wherein the analysis system is operative to output suspected faults in a ranked format.

20. The system of claim 14, further comprising the gas turbine engine.
